(19) United States
(12) Patent Application Publication
(10) Pub. No.: US 2008/0168143 A1
(43) Pub. Date: Jul. 10, 2008

(54) CONTROL SYSTEM OF INTERACTIVE TOY SET THAT RESPONDS TO NETWORK REAL-TIME COMMUNICATION MESSAGES

(75) Inventors: Yuh-Wen SHIEH, TAIPEI HSIEN (TW); Yao-Lung TSAI, TAIPEI HSIEN (TW); Shan-Yi FANG, Keelung City (TW)

Correspondence Address: PATENTTM.US, P. O. BOX 82788, PORTLAND, OR, 97282-0788, US

(73) Assignee: ALLGATES SEMICONDUCTOR INC., Taipei Hsien (TW)

(21) Appl. No.: 11/691,427

(22) Filed: Mar. 26, 2007

(30) Foreign Application Priority Data
Jan. 5, 2007 (TW) 096100640

(51) Int. Cl. G06F 15/16

(52) U.S. Cl. 709/206

(57) ABSTRACT

A control system of an interactive toy set that responds to network real-time communicating messages has at least two toys and two network computer devices connected to the toys, respectively. Each toy has a processor built in with a table of corresponding real-time communicating messages and control commands. Each computer device is built in with real-time communicating software and conversion software. Once the real-time communicating software starts running, one or several remote computer devices that are in communications with the local computer device are obtained by the conversion software. Communicating messages are then exchanged between the local and remote computer devices. The communicating messages are then sent to the toy. According to the table, the processor controls the toy to perform the corresponding motions. Therefore, the player can make the toy respond according to the communicating messages, increasing the fun of remote communications.

### BACKGROUND OF THE INVENTION

1. Field of the Invention

The invention relates to a control system for a network toy. In particular, the invention relates to a control system of an interactive toy set that responds to network real-time communicating messages. The player using the network for communications can present the communicating contents through the toys.

2. Description of Related Art

Toys have been an ingredient for increasing fun in life. Both adults and children have their own favorite kinds of toys. The primary reason for toys to attract people is their novel functions and features. This forces the industry to invest a lot in researches. In particular, the prevalence of network games has drawn many toy manufacturers to make puppets that can be controlled by the network games.

### SUMMARY OF THE INVENTION

An objective of the invention is to provide a control system of an interactive toy set that can respond to network real-time communicating messages. After connecting the toy to a computer device running the real-time communication function, the player can use the toy to present real-time communicating messages transmitted from the other party. This adds fun to the real-time communication.

To achieve the above objective, the disclosed control system has at least two toys and at least two computer devices.

Each toy includes a processor and several action units connected with the processor. Each action unit is controlled by the processor. The processor is further built in with a look-up table of real-time communicating messages and corresponding control commands and a message responding procedure.

Each of the computer devices is connected with the corresponding toy and to a network. Each computer device is built in with real-time communicating software and conversion software in communication with each other. The conversion software captures communicating messages with the remote computer device once the real-time communicating software starts.

The message responding procedure of the processor in each toy is as follows. After the associated computer device transmits a communicating message to the toy, the action units of the toy are controlled to act. That is, the processor reads the look-up table of real-time communicating message and the corresponding control commands and compares the currently received communicating message with the table, obtaining the corresponding control command. The corresponding action units make the corresponding actions according t o the control command. For example, if a “smile” message is received from the remote computer device, the action unit (such as a motor) disposed at the mouth is opened to reflect meaning of the currently received message.

Another objective of the invention is to increase the functions of the above-mentioned toy. Although the toy can respond according to the currently received real-time communicating message, it is only a one-way control. Each toy can be provided with several sensors of different natures, and the sensors are connected with the internal processor. When the player plays with the toy alone, any touch is detected by the sensors and a corresponding electronic signal is sent to the processor. The processor controls the corresponding action units according to the electronic signal, so that the toy can receive the player's control and make responses. Therefore, in addition to acting according to the real-time communicating message output from the computer device, the toy can interact with the player directly, achieving the function of mutual controls.

A further objective of the invention is to add the function of remote control to the toy. A remote control receiver is disposed in each toy and connected with its processor for receiving remote control signals sent from an external remote control. Consequently, the player can use the remote control to control local and remote toys to act, rendering a remote-control toy.

### BRIEF DESCRIPTION OF THE DRAWINGS

FIG. 1 is a schematic view showing the system structure of the control system in a first embodiment in accordance with the present invention;

FIG. 2 is the functional block diagram of each toy in accordance with the present invention;

FIG. 3 is a look-up table of real-time communicating messages and corresponding control commands in accordance with the present invention;

FIG. 4 is a flowchart of the message responding procedure for the processor of each toy in accordance with the present invention;

FIG. 5 is a flowchart of how each computer device executes the real-time communicating software and conversion software in accordance with the present invention;

FIG. 6 shows a window of the running real-time communicating software in accordance with the present invention; and

FIG. 7 is a schematic view showing the system structure of the control system in a second embodiment in accordance with the present invention.

### DETAILED DESCRIPTION OF THE PREFERRED EMBODIMENT

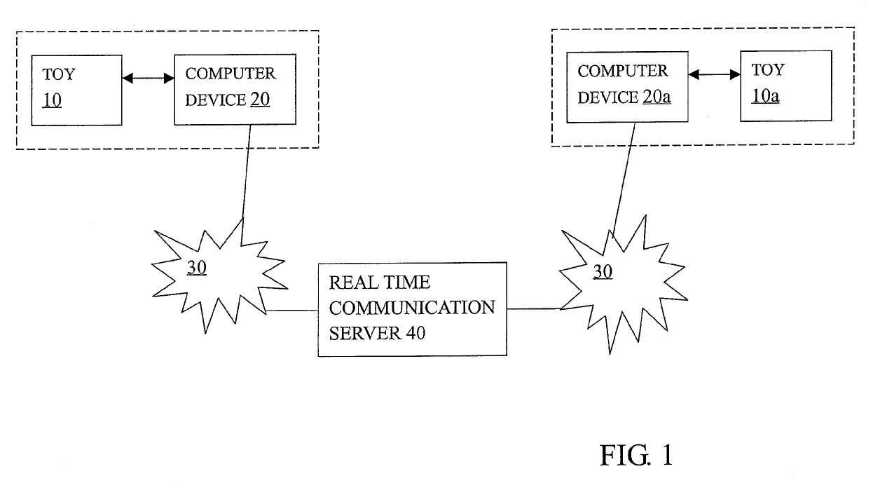

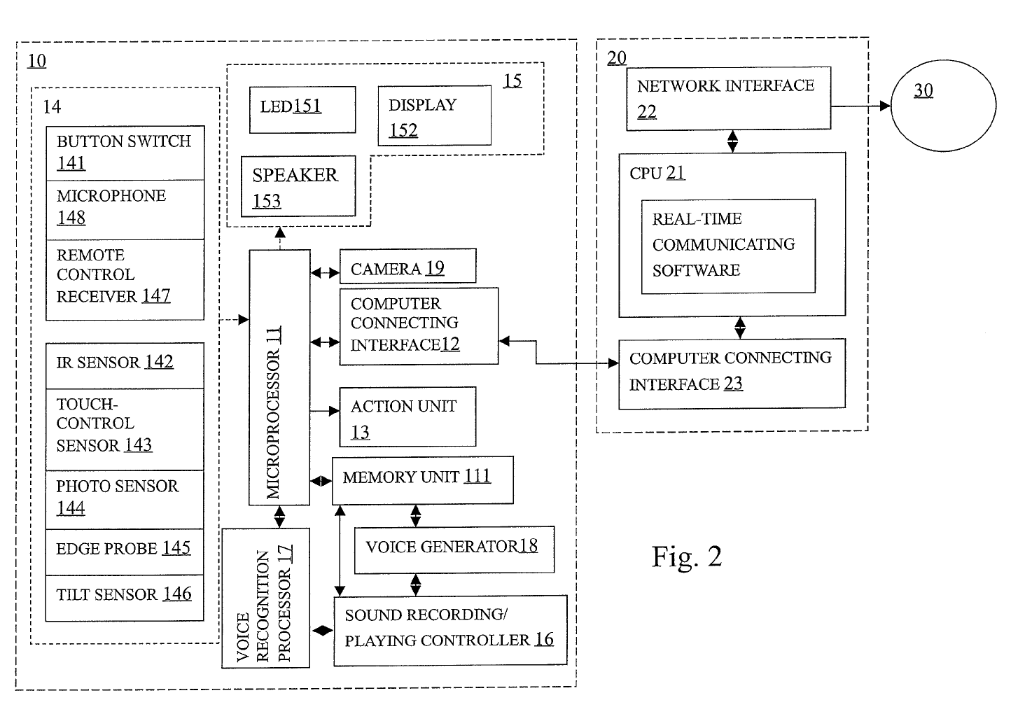

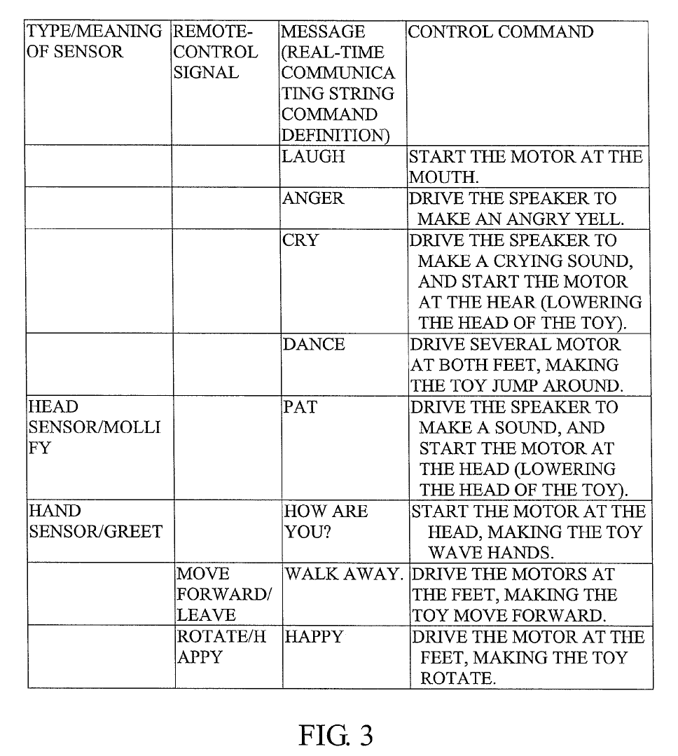

A control system according to a first embodiment of the present invention is shown in FIGS. 1 and 2. The control system has at least two toys 10, 10a and at least two computer devices 20, 20a. Each of the toys 10, 10a includes a processor 11 and several action units 13 connected with the processor 11. Each action unit 13 is controlled by the processor 11. The processor 11 is further built in with a look-up table of real-time communicating messages and corresponding control commands (as shown in FIG. 3) and a message responding procedure.

Each of the computer devices 20, 20a is linked to the corresponding toy 10, 10a and also the Internet 30. Each computer device 20, 20a has a central processor 21, a network interface 22, and a computer connecting interface 23. Each computer device 20, 20a is also built in with real-time communicating software (MSN®, Skype™, Google™, or Orb™) and conversion software. The conversion software is in communications with the real-time communicating software for extracting communicating messages between the real-time communicating software and the remote computer device. The communicating message is transmitted to the toy 10, 10a at the local end of the computer device 20, 20a. The player can readily connect to the Internet using a non-static IP address of the real-time communicating software.

FIG. 2 shows an internal functional block diagram of the toys 10, 10a. Each toy 10, 10a has a processor 11, a computer connecting interface 12, at least one action unit 13, an input device 14, an output device 15, a sound recording and playing controller 16, and a video camera 19.

The processor 11 is connected with a memory unit 111. The computer connecting interface 12 is connected with the processor 11 for the connection with a computer connecting interface 23 of the corresponding computer device 20, 20a. Such a connection can be wired or wireless (e.g., RS-232, USB, PS2, BLUETOOTH, IR, RF, etc). The action unit 13 is disposed at an appropriate position in the toy 10, 10a and connected to the output terminal of the processor 11. The action unit 13 acts according to the output signal of the processor 11, so that the toy 10, 10a makes an action. The input device 14 is connected to the input terminal of the processor 11 and has a button switch, at least one sensor (e.g. IR sensor 142, touch-control sensor 143, photo sensor 144, edge probe 145, tilt sensor 146, etc), a remote control receiver 147, and a microphone 148. The output device 14 is connected to the output terminal of the processor 11 and controlled by the processor 11. The output device 14 has LED lights 151, a display 152, and a speaker 153. The sound recording and playing controller 16 is connected to the processor 11 via a voice recognition processor 17 and to the memory unit 11 of the processor 11 via a voice generator 18. It can be directly connected to the memory unit 11 as well. The video camera 19 is connected to the processor 11. In addition to sending the captured images to the processor 11, the video camera 19 is also controlled by the processor 11 to change its video-taping direction and angle.

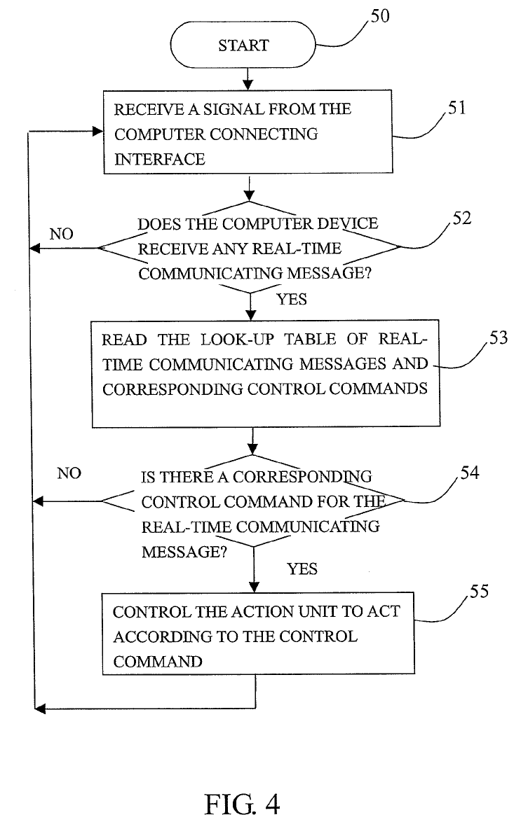

A flowchart of the above-mentioned message responding procedure in the processor of each toy is given in FIG. 4. It includes the following steps.

Step 50 starts. Step 51 receives a signal from the computer connecting interface. Step 52 determines whether the computer device receives a real-time communicating message. If so, the next step follows. Step 53 reads the look-up table of real-time communicating messages and control commands. Step 54 compares the received real-time communicating message with the look-up table and finds the corresponding control command. Step 55 controls the corresponding action units on the toy to perform a specific action corresponding to the control command. For example, the first column of the look-up table in FIG. 3 defines the control command corresponding to the real-time communicating message “smile” is to rotate a motor disposed at the mouth of the toy. Therefore, the motor rotates to open the mouth of the toy, presenting a smiling face.

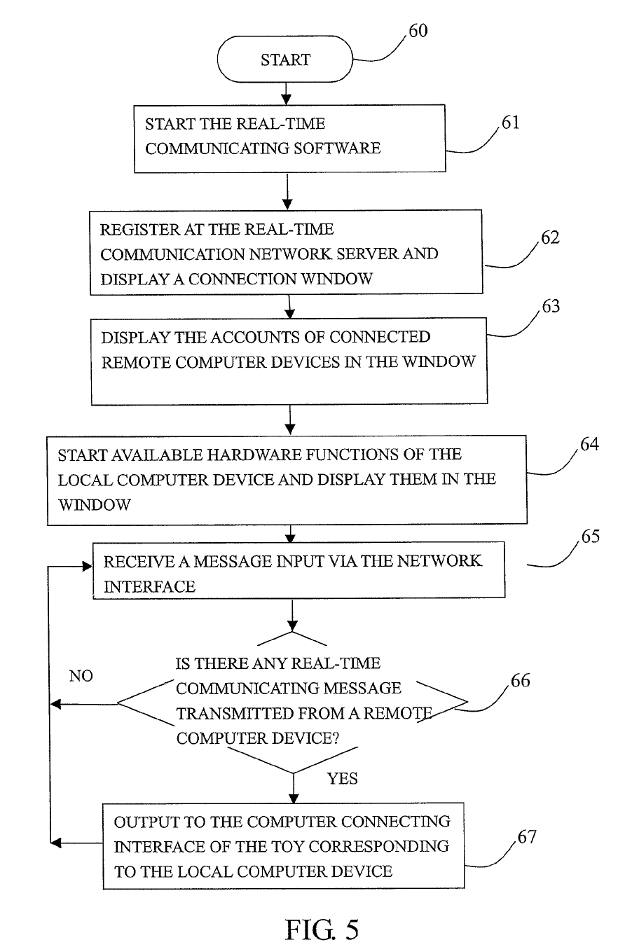

An operation flowchart of the real-time communicating software and the conversion software executed by the computer device is shown in FIG. 5. It includes the following steps.

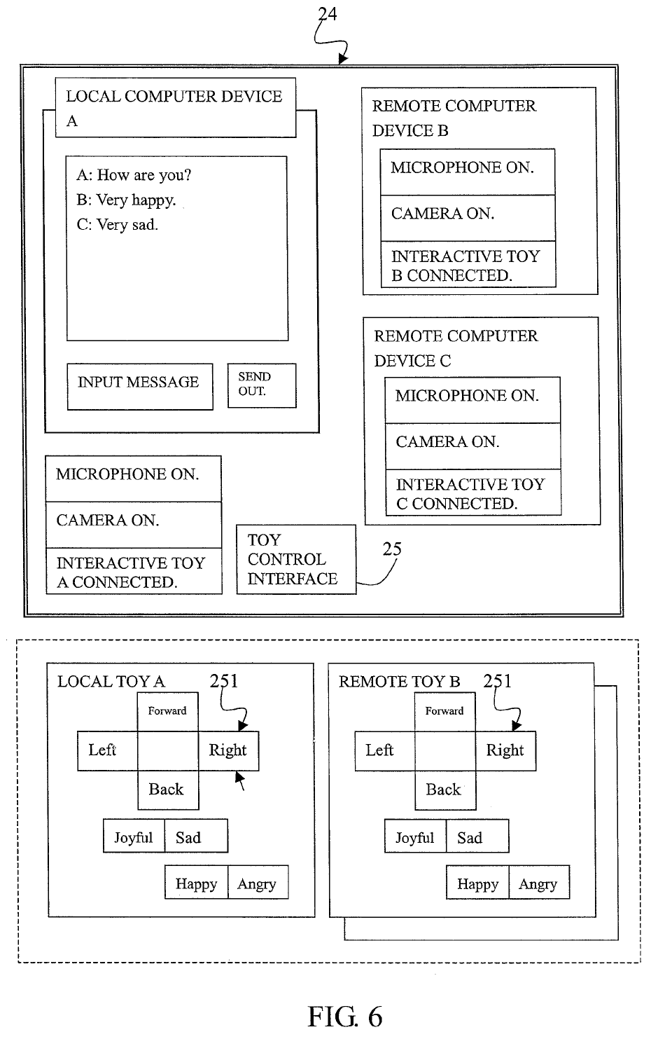

Step 60 starts. Step 61 starts the real-time communicating software. With further reference to FIG. 6, step 62 registers the real-time communication network server, displaying a connection window. In step 63, accounts of default remote computers are searched on the server, and all connected remote computer accounts are displayed in a window 24. The available hard functions (e.g., the microphone, video camera, and toy) of the local computer device are initiated and displayed in the window 24 in step 64. Step 65 receives a message from the network interface. Step 66 determines whether there is any message from a remote computer device. If so, then the message is output to the computer connecting interface 57 of the toy corresponding to the local computer device in step 67. Step 65 through Step 67 are repeated.

The window 24 further has a toy control interface 25 with various functional keys 251 for local and remote toys. Each functional key is defined with a real-time communicating message. As shown in FIG. 3, the player can directly press the functional key for the local or remote toy so that the local or remote toy make the corresponding action after receiving the defined message thereof.

As shown in FIGS. 4 and 5, when two players at different places establish a real-time communicating connection via the Internet, each player can see whether the computer device of the other person is connected with the disclosed toy. If both players are using the disclosed toys, then one can send a message to the computer device of the other, making player's toy act according to the meaning of the message. Therefore, the toys at different places have an interactive effect. Since the toy can reflect the message content and allows the player to send messages in text or voices via the real-time communication, there is another intriguing toy with more fun.

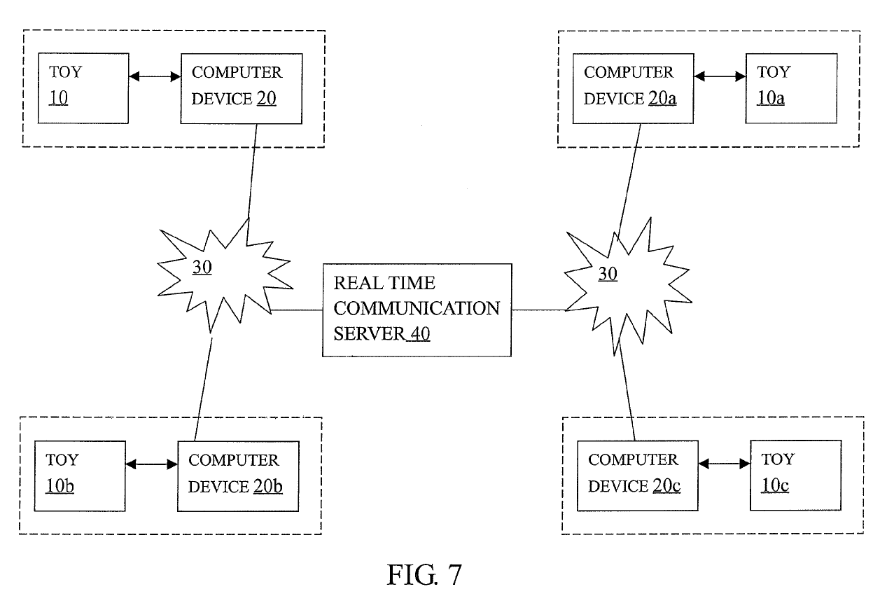

FIG. 7 shows a second embodiment of the control system in accordance with present invention. The control system is completely the same as that in FIG. 1. However, it has more than two toys 10, 10a, 10b, 10c and the corresponding computer devices. Once the real-time communication is established, one can communicate with several remote computer devices 20, 20a, 20b, 20c. Therefore, when the local computer device 20 sends out one message to the toys 10a, 10b, 10c of more than two remote computer devices using the broadcasting function of the real-time communication, then the corresponding toys act in the same way. This achieves the many-to-many interactive communication.

Although the above-mentioned toys can act according to the received real-time communicating messages, they merely have one-way control. To increase the fun, each toy can be disposed with several sensors of different natures (e.g., IR sensor, touch-control sensor, photo sensor, edge probe, tilt sensor, IR receiver, microphone, video camera, etc). In this case, the toy is not only controlled by the computer device, its input devices also allow the player to directly play with the toys and trigger the input devices. When the processor receives an output signal from the corresponding input device, it controls the toy to respond accordingly. Therefore, the toy achieves two-way control.

Moreover, in addition to the action unit disposed in the toy, the toy can present more expressions or emotions because of the use of input devices (including LED's, display, speaker, etc). According to one embodiment of the invention, it is provided with a sound recording and playing controller for the player to record voices. With a voice recognition processor, the processor can distinguish the voice features and contents of different players, making the toys more human.

In one embodiment of the invention, the input device of the disclosed toy is provided with a remote control receiver 147. The remote control receiver 147 is connected with the processor 11 and receives remote control signals sent out from an external remote control. As shown in FIG. 3, each remote control signal has its corresponding real-time communicating message. After the processor 11 receives the message via the remote control receiver 147, it makes the local and remote toys to perform the corresponding action. The toy thus becomes a remote-control toy with more fun.

In summary, the invention indeed provides a toy control system that utilizes network real-time communication to achieve interactive controls. This does not only enable two or more toys to control one another in an interactive way, but also let the toys to act according to the content of the real-time communicating message. With the functions provided by the real-time communicating software, the invention achieves one-to-one, one-to-many, many-to-one, and many-to-many playing schemes.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A control system of an interactive toy set that respond to network real-time communicating messages, comprising:
at least two toys, each of which is disposed with a processor and a plurality of action units connected with and controller by the processor, wherein the processor is built in with a look-up table of real-time communicating messages and corresponding control commands and a message responding procedure; and
at least two computer device linked to each other via Internet, wherein each of the at least two computer device is connected with its corresponding toy and to Internet and is built in with real-time communicating software and a conversion software, the conversion software is linked with the real-time communicating software for extracting communicating messages between the real-time communicating software and the other computer device on the Internet and transmitting the message to the toy connected with a computer device.

2. The control system as claimed in claim 1, wherein each toy comprises:
a memory unit connected with the processor;
a computer connecting interface connected with the processor for the connection of the corresponding computer device;
an input device connected to the processor and provided with a button switch and at least one sensor; and
an output device disposed outside the toy and connected to the output terminal of and controlled by the processor therein.

3. The control system as claimed in claim 1, wherein each toy further comprises a sound recording and playing controller connected to the processor via a voice recognition processor and to the memory via a voice generator.

4. The control system as claimed in claim 1, wherein each toy has a sound recording and playing controller connected to the processor via a voice recognition processor and to the memory unit of the processor directly.

5. The control system as claimed in claim 2, wherein the sensor of the input device is an infrared (IR) sensor, touch-control sensor, photo sensor, edge probe, or tilt sensor.

6. The control system as claimed in claim 2, wherein the input device includes a remote control receiver for receiving remote control signals from an external remote control.

7. The control system as claimed in claim 5, wherein the input device includes a remote control receiver for receiving remote control signals from an external remote control.

8. The control system as claimed in claim 2, wherein the processor is connected with a video camera and controls the video camera to capture images in different directions and angles and send the captured images to the computer device via the computer connecting interface.

9. The control system as claimed in claim 2, wherein the output device further comprises a display and a speaker, both connected with the processor.

10. The control system as claimed in claim 2, wherein the computer connecting interface is connected to the computer device in a wired or wireless connection.

11. The control system as claimed in claim 10, wherein the computer connecting interface is an RS-232, USB, PS2, BLUETOOTH, IR, or RF interface.

12. The control system as claimed in claim 1, wherein the message responding procedure of the processor comprises steps of:
determining whether the computer device enters a real-time communicating message and continuing to the next step if yes;
reading the look-up table of real-time communicating messages and corresponding control commands;
comparing the received real-time communicating message with the look-up table and reading out the corresponding control command; and
controlling a corresponding action unit of the toy to perform an action according to the control command.

13. The control system as claimed in claim 1, wherein each computer device executes steps of:
starting the real-time communicating software;
registering on the real-time communication network server and displaying a connection window;
searching accounts of default remote computer devices on the server and displaying the accounts of connected remote computer devices in the connection window;
starting available hardware functions of the computer device and displaying the available hardware functions in the window;
detecting whether any message is transmitted from the other computer device and, if yes, outputting it to the computer connecting interface of the toy connected with the computer device; and
repeated the previous step.

14. The control system as claimed in claim 12, wherein each computer device executes steps of:
starting the real-time communicating software;
registering on the real-time communication network server and displaying a connection window;
searching accounts of default remote computer devices on the server and displaying the accounts of connected remote computer devices in the connection window;
starting available hardware functions of the computer device and displaying the available hardware functions in the window;
detecting whether any message is transmitted from the other computer device and, if yes, outputting it to the computer connecting interface of the toy connected with the computer device; and
repeated the previous step.

15. The control system as claimed in claim 13, wherein the window has control keys for local and remote toys, each of which is defined with a real-time communicating message, so that when one of the control keys for a local/remote toy is clicked, the local/remote toy performs a corresponding action according to the received communicating message associated with the control key.

16. The control system as claimed in claim 14, wherein the window has control keys for local and remote toys, each of which is defined with a real-time communicating message, so that when one of the control keys for a local/remote toy is clicked, the local/remote toy performs a corresponding action according to the received communicating message associated with the control key.
